(19) United States
(12) Patent Application Publication
(10) Pub. No.: US 2012/0133473 A1
(43) Pub. Date: May 31, 2012

(54) INDUCTIVE COMPONENT HAVING TERMINAL WINDING

(75) Inventors: YUEH-SHAN SHIH, New Taipei (TW); LUN-TSU HUANG, New Taipei (TW); JIE ZHANG, Kunshan (CN); JIAN-SHE HU, Kunshan (CN)

(73) Assignee: HON HAI PRECISION INDUSTRY CO., LTD., New Taipei (TW)

(21) Appl. No.: 13/307,323

(22) Filed: Nov. 30, 2011

(30) Foreign Application Priority Data
Nov. 30, 2010 (CN) 201020633348.1

(51) Int. Cl. H01F 5/00

(52) U.S. Cl. 336/200

(57) ABSTRACT

An inductive component formed on a substrate (11) includes a number of conductive traces (111) exposed to air on the substrate, a core (13), and a number of terminals (12). The core is disposed on one side of the substrate and between the terminal and the conductive traces. The core is a toroidal core. The conductive traces connect with the terminals to form at least one conductive path winding around the core.

### BACKGROUND OF THE INVENTION

1. Field of the Invention

The present invention relates to an inductive component, and more particularly to an inductive component having terminal winding.

2. Description of Related Art

U.S. Pat. Nos. 6,690,257, 6,522,230, and 4,347,490 each disclose an inductive component including a core and a plurality of coils winding around the core. In these prior arts, the coils wind around the core to form an inductive component. However, the winding process is complex and time-consuming.

U.S. Pat. No. 6,249,039 discloses an integrated inductive component formed on a substrate. The inductive component includes a plurality of first conductive elements buried in the substrate, a magnetic core, and a plurality of second conductive elements passing over the core to connect with the first conductive elements. The first and second conductive elements take place of the coils referred to in U.S. Pat. Nos. 6,690,257, 6,522,230, and 4,347,490. The component is fabricated by a method in which it is built up in a shallow concavity or trench using thin film techniques, whereby the inductive component can be manufactured as part of an integrated circuit.

Hence, an inductive component having an improved structure of terminal winding is desired.

### SUMMARY OF THE INVENTION

Accordingly, an object of the present invention is to provide an inductive component having a simple substrate layer and a good magnetic conductivity.

In order to achieve the object set forth, the invention provides an inductive component formed on a substrate. The inductive component includes a plurality of first conductive traces exposed to air on the substrate, a core disposed at an upper side of the substrate, and an array of terminals passing over the core and connecting with the first conductive traces to form at least one conductive path winding around the core.

The core has a magnetic core and a core insulation layer surrounding the magnetic core. The core is a toroidal core including a hole, and the terminals passing through the hole.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an inductive component in accordance with a first embodiment of the present invention;

FIG. 2 is an exploded view of the inductive component shown in FIG. 1;

FIG. 3 is a perspective view of an inductive component in accordance with a second embodiment of the present invention;

FIG. 4 is an exploded view of the inductive component shown in FIG. 3;

FIG. 5 is a perspective view of a inductive component in accordance with a third embodiment of the present invention; and

FIG. 6 is an exploded view of the inductive component shown in FIG. 5.

FIG. 7 is a perspective view of a inductive component in accordance with a fourth embodiment of the present invention; and

FIG. 8 is an exploded view of the inductive component shown in FIG. 7.

FIG. 9a is a schematic diagram of the first embodiment.

FIG. 9b is a schematic diagram of the second embodiment.

FIG. 9c is a schematic diagram of the third embodiment.

FIG. 9d is a schematic diagram of the fourth embodiment.

### DETAILED DESCRIPTION OF THE PREFERRED EMBODIMENT

Reference will now be made in detail to the preferred embodiment of the present invention.

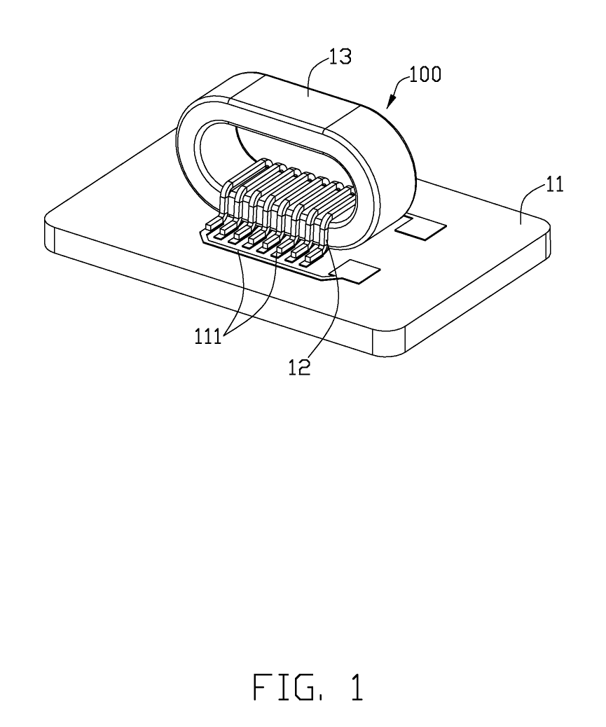

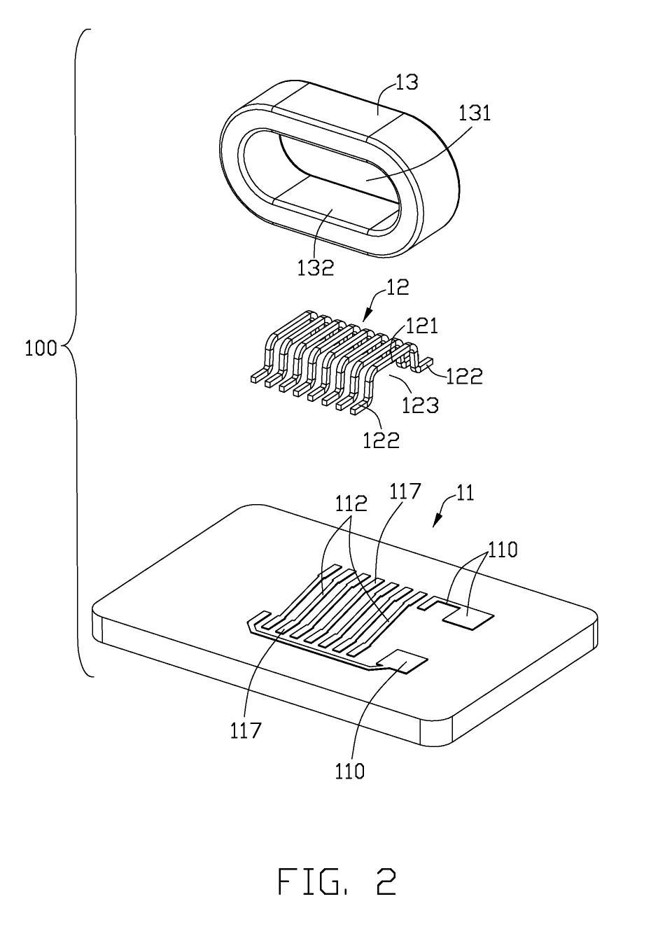

Referring to FIGS. 1-2, an inductive component according to a first embodiment of the present invention is an inductor 100. The inductor 100 is formed on a printed circuit board 11. The inductor 100 includes a plurality of first conductive traces 111 disposed on the printed circuit board 11, a core 13 disposed at the upper side of the printed circuit board 11, and an array of terminals 12 passing over the core 13 to connect with first conductive traces 111.

The first conductive traces 111 are disposed at the upper face of the printed circuit board 11 and exposed to air. The first conductive traces 111 include an array of middle wires 112, and a pair of first ends 110 respectively for inputting and outputting. The middle wires 112 are parallel with each other. Each of the middle wires 112 has two conductive pads 117 for connecting one terminal 12 to another terminal 12. The first ends 110 are used for connecting a peripheral equipment.

Each of the terminals 12, preferably preformed by suitable known contact forming operations, has two end portions 122 and a middle portion 121 connected with the end portions 122. The middle portion 121 is of U-shape and protrudes upwardly from the end portions 122. The terminal 12 defines an opening 123 below the middle portion 121 for receiving the core 13.

In FIGS. 1-2, the core 13 is a toroidal core including a hole 131 and a lower section 132 below the hole 131. The core 13 has a magnetic core and a core insulation layer surrounding the magnetic core. The core 13 is not limited as a toroidal core, and it could be formed into rectangle or other types. However, the toroidal core's magnetic conductivity is better than the other types.

In assembling, the core 13 is fixed at the upper side of the middle wires 112 by glue. The middle portions 121 of the terminals 12 pass through the hole 131, the end portions 122 of the terminals 12 are soldered to the conductive pads 117, and the lower section 132 of the core 13 is received in the openings 123. In FIGS. 1-2, the terminals 12 are surface mounted to the printed circuit board 11. Certainly, the terminals 12 could also be press fit or through hole mounted to the printed circuit board 11.

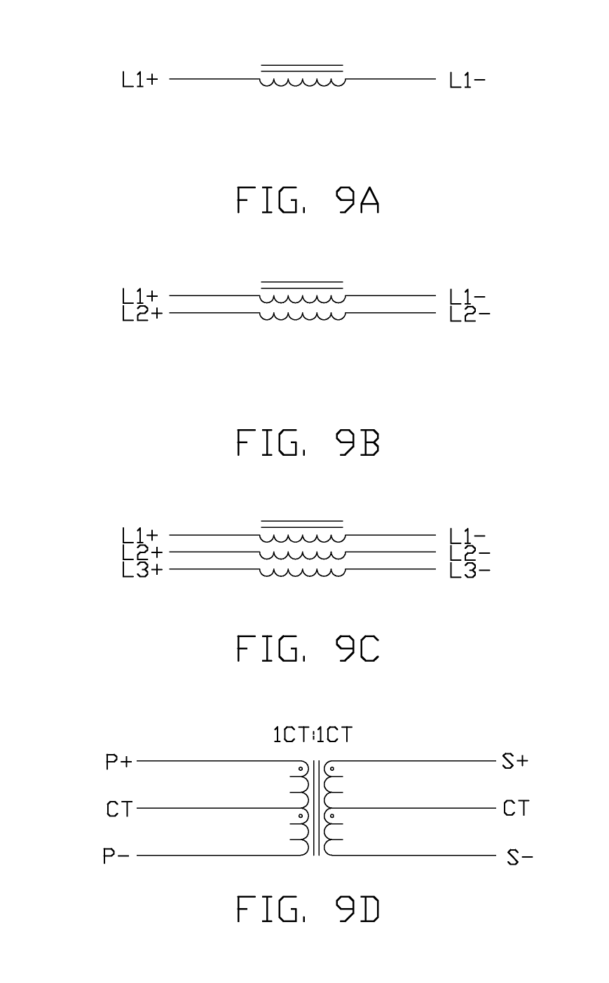

After the core 13 and the terminal 12 are assembled to the printed circuit board 11, the core 13 is disposed between the middle wire 112 and the terminals 12. A first end 110 connects to a terminal 12, a terminal 12 connects with another terminal 12 though a middle wire 112, and a terminal 12 connects to the other first end 110. The terminals 12 are connected with the middle wires 112 to form one conductive spiral path winding around the core 13. FIG. 9a is the schematic diagram of the inductor 100. The first ends 110 or L1+/L1− connect with the conductive spiral paths. The terminals 12 enclose a first section of the core 13, and the first conductive traces 111 enclose a second section of the core 13. The first conductive traces 111 are exposed to air on the printed circuit board 11, therefore, the printed circuit board 11 could formed less layers than that of U.S. Pat. No. 6,249,039.

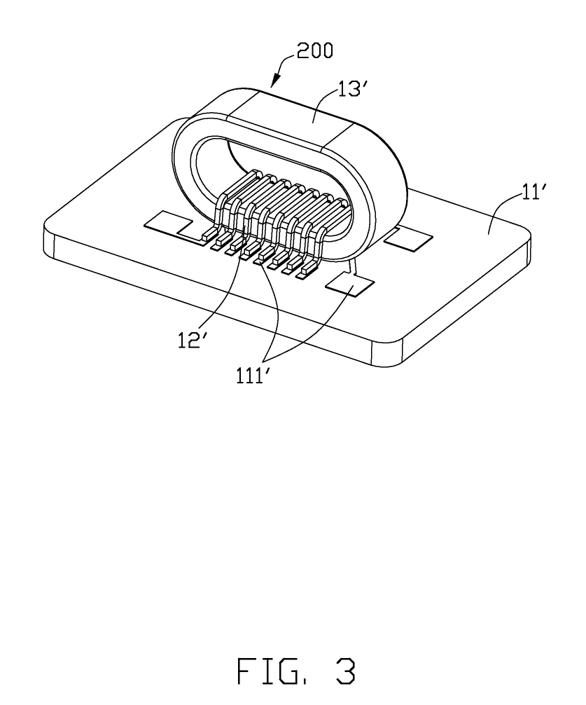

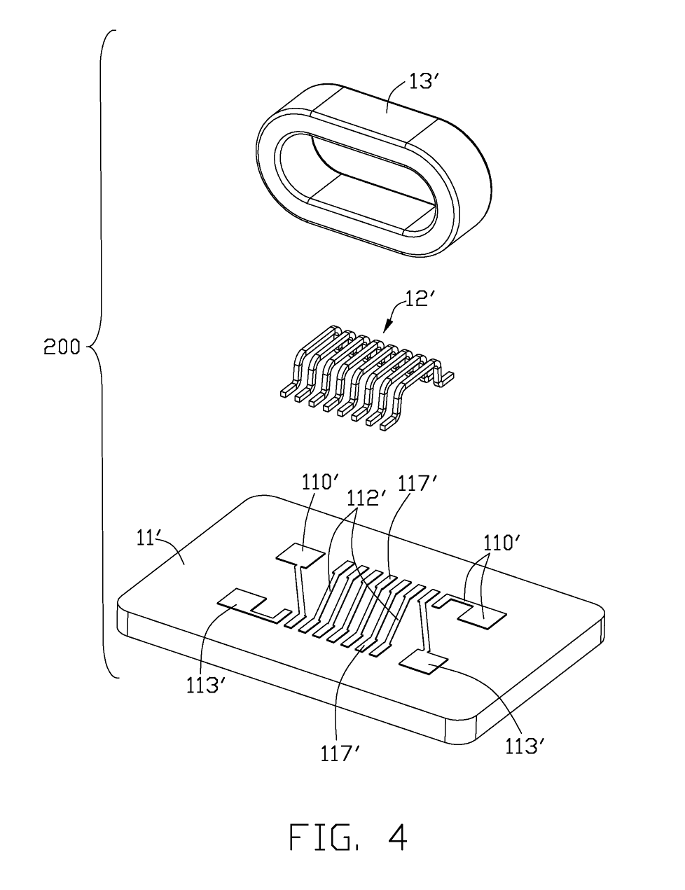

Referring to FIGS. 3-4, an inductive component according to a second embodiment of the present invention is a 2-wire CMC (common mode choke). The 2-wire CMC 200 is formed on a printed circuit board 11′. The 2-wire CMC 200 includes a plurality of first conductive traces 111′ exposed to air on the printed circuit board 11′, a core 13′ disposed at the upper side of the printed circuit board 11′, and an array of terminals 12′ passing over the core 13′ to connected with the first conductive traces 111′. The first conductive traces 111′ include an array of middle wires 112′ including contact portions 117′, a pair of first ends 110′, and a pair of second ends 113′. These ends 110′, 113′ are used for connecting a peripheral equipment. The terminals 12′ and the core 13′ are same to that of the first embodiment.

After the core 13′ and the terminal 12′ are assembled to the printed circuit board 11′, the core 13′ is disposed between the middle wire 112′ and the terminals 12′. A first end 110′ connects to a terminal 12′, a terminal 12′ connects with another terminal 12′ though a middle wire 112′, and a terminal 12′ connects to the other first end 110′. A second end 113′ connects to a terminal 12′, a terminal 12′ connects with another terminal 12′ though a middle wire 112′, and a terminal 12′ connects to the other second end 113′. The terminals 12′ are connected with the middle wires 112′ to form two conductive spiral paths winding around the core 13′. FIG. 9b is a schematic diagram of the 2-wire CMC 200. The first ends 110′ or L1+/L1− connect with one of the conductive spiral paths. The second ends 113′ or L2+/L2− connect with the other of the conductive spiral paths.

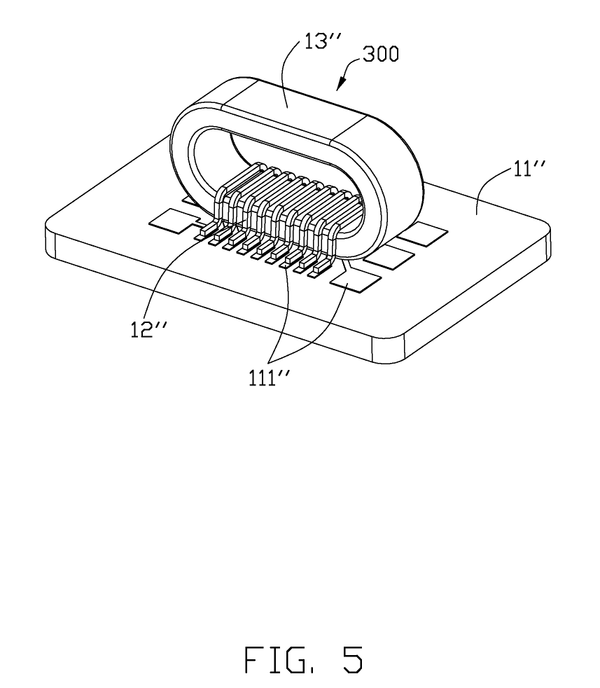

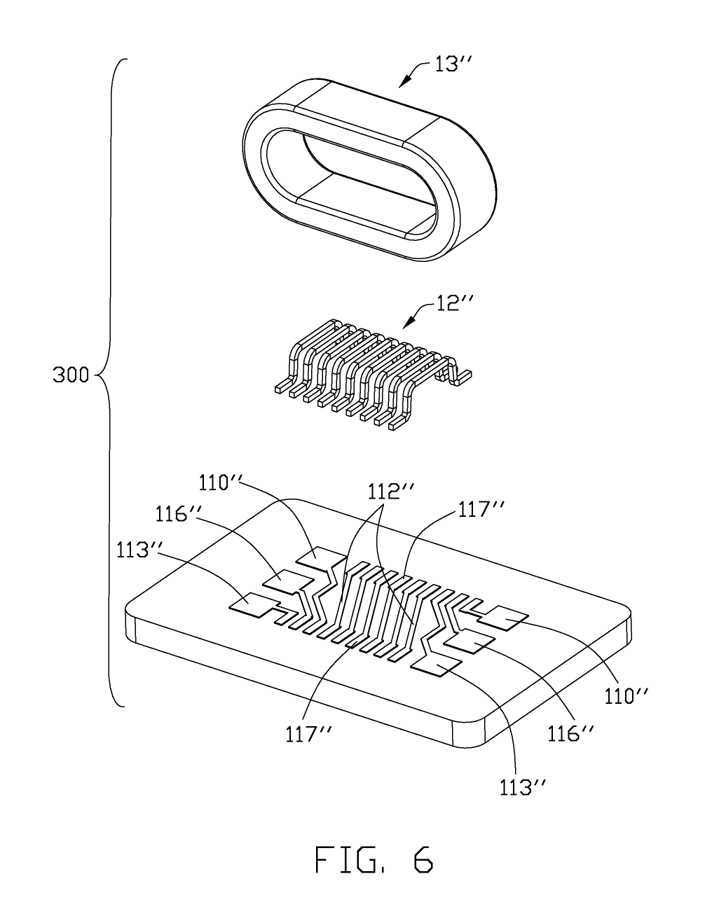

Referring to FIGS. 5-6, an inductive component according to a third embodiment of the present invention is a 3-wire CMC (common mode choke). The 3-wire CMC 300 is formed on a printed circuit board 11″. The 3-wire CMC 300 includes a plurality of first conductive traces 111″ exposed to air on the printed circuit board 11″, a core 13″ disposed at the upper side of the printed circuit board 11″, and an array of terminals 12″ passing over the core 13″ to connected with the first conductive traces 111″. The first conductive traces 111″ include an array of middle wires 112″ including contact portion 117″, a pair of first ends 110″, a pair of second ends 113″, and a pair of third ends 116″. These ends 110″, 113″, 116″ are used for connecting a peripheral equipment. The terminals 12″ and the core 13″ are same to that of the first embodiment.

After the core 13″ and the terminal 12″ are assembled to the printed circuit board 11″, the core 13″ is disposed between the middle wire 112″ and the terminals 12″. The terminals 12″ are connected with the middle wires 112″ to form three conductive spiral paths winding around the core 13″. FIG. 9c is a schematic diagram of the 3-wire CMC 300. The first ends 110″ or L1+/L1− connect with a first spiral path. The second ends 113″ or L2+/L2− connect with a second conductive spiral path. The third ends 116″ or L3+/L3− connect with a third conductive spiral path.

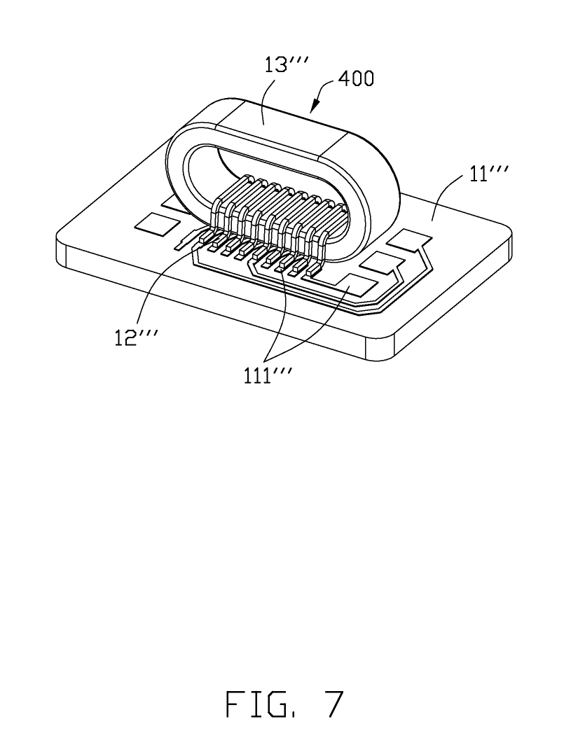

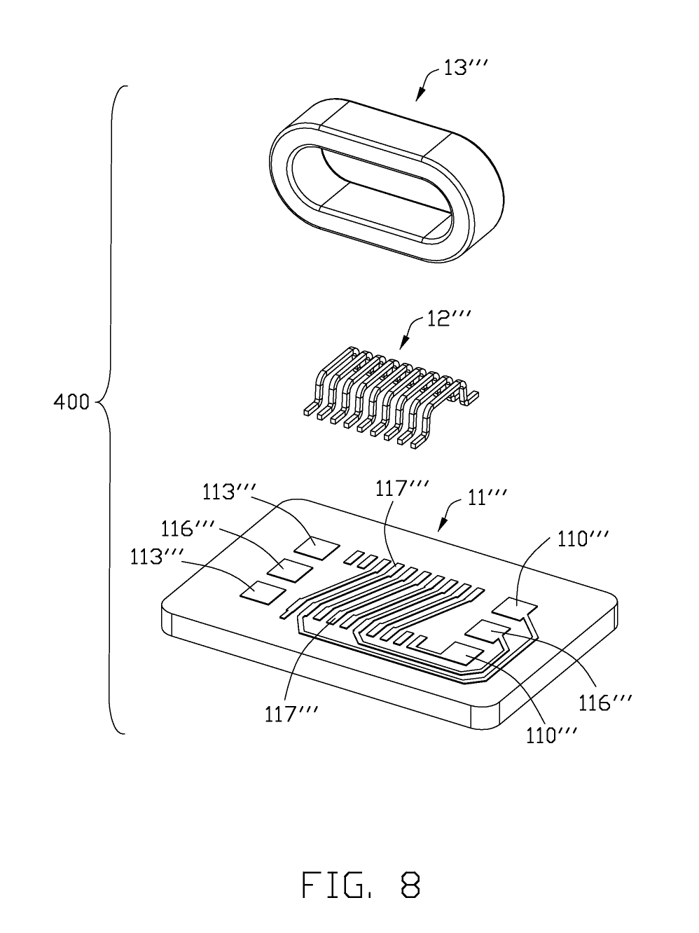

Referring to FIGS. 7-8, an inductive component according to a fourth embodiment of the present invention is a transformer 400. The transformer 400 is formed on a printed circuit board 11″′. The transformer 400 includes a plurality of first conductive traces 111″′ exposed to air on the printed circuit board 11″′, a core 13″′ disposed at the upper side of the printed circuit board 11″′, and an array of terminals 12″′ passing over the core 13″′ to connected with the first conductive traces 111″′. The first conductive traces 111′″ include a plurality of middle wires 112″′ including contact portions 117″′, a pair of first ends 110″′, a pair of second ends 113″′, and a pair of third ends 116″′. These ends 110″′, 113″′, 116″′ are used for connecting a peripheral equipment. The terminals 12″′ and the core 13″′ are same to that of the first embodiment.

After the core 13″′ and the terminal 12″′ are assembled to the printed circuit board 11 ′″, the core 13″′ is disposed between the middle wire 112″′ and the terminals 12″′. The circuit board 11″′ including an insulative layer and a plurality of second conductive traces buried in the insulative layer. The terminals 12″′ connect with the first conductive traces 111′″ to form two spiral conductive spiral paths winding around the core 13″′. The second conductive traces connect the first conductive traces to the two second ends 113″′ and one third end 116″′. FIG. 9d is a schematic diagram of the transformer 300. The first ends 110″′ or P+/P− connect with a first spiral path which could be a primary winding of the transformer 400. The second ends 113″′ or S+/S− connect with a second conductive spiral path which could be a secondary winding of the transformer 400. The third ends 116″′ or CT connect with a central tap of the transformer 400.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An inductive component formed on a substrate, comprising:
a plurality of first conductive traces disposed on one side of the substrate;
a core disposed on the substrate over the first conductive traces; and
an array of terminals passing over the core and connecting with the first conductive traces to form at least one conductive path winding around the core.

2. The inductive component as claimed in claim 1, wherein said core is a toroid including a punch hole, said terminals passing through the hole.

3. The inductive component as claimed in claim 1, wherein said first conductive traces include an array of middle traces, each of the middle traces having two contact portions for connecting with the terminals.

4. The inductive component as claimed in claim 3, wherein said middle traces are parallel with each other.

5. The inductive component as claimed in claim 3, wherein said contact portions are constituted of pads, and each of the terminals has two end portions connecting to the pads and a middle portion passing over the core.

6. The inductive component as claimed in claim 5, wherein said middle portion of the terminal is of U-shape, and said terminal defines an opening below the middle portion for receiving the core.

7. The inductive component as claimed in claim 1, wherein said inductive component is an inductor, said inductor including one conductive path winding around the core.

8. The inductive component as claimed in claim 1, wherein said inductive component is a common mode choke, said common mode choke including two or three conductive paths winding around the core.

9. The inductive component as claimed in claim 1, further including a plurality of second conductive traces buried in the substrate and connected with the first conductive traces, said array of terminals connecting with the first conductive traces to form two conductive paths winding around the core.

10. The inductive component as claimed in claim 9, wherein said inductive component is a transformer.

11. An electrical assembly comprising:
a printed circuit board equipped with on a trace area a plurality of circuit traces parallel to one another, each of said circuit traces defining two opposite connection areas which are essentially located on two opposite sides of the trace area;
a plurality of contacts soldered upon the printed circuit board in a parallel relation with one another, each of the contacts having two connection sections around two opposite ends thereof under condition that one of said two connection sections is connected to the connection area of one corresponding trace around one side of the trace area while the other of said two connection sections is connected to the connection area of another corresponding trace around the other side of the trace area, whereby the contacts and the traces are roughly alternatively arranged with each other to commonly form a series of conductors with a conductive path thereof; and
a magnetic core having a segment extending through a space defined between said contacts and said traces so as to result in said series of conductors winding along said segment for induction.

12. The electrical assembly as claimed in claim 11, wherein the traces are exposed upon a surface of the printed circuit board.

13. The electrical assembly as claimed in claim 12, wherein said magnetic core is fastened upon said surface.

14. The electrical assembly as claimed in claim 11, wherein each of said contacts connects every other corresponding traces so as to form two conductive paths along the segment analogous to a two-wire common mode choke.

15. The electrical assembly as claimed in claim 11, wherein each of said contacts connects every other two corresponding traces so as to form three conductive paths along the segment analogous to a three-wire common mode choke.

16. A pseudo inductor device comprising:
a conductive path winding along a segment of a magnetic core to form induction thereof; wherein
said conductive path is defined by a plurality of discrete contacts and a plurality of traces associated with a printed circuit board in an alternate manner.

17. The pseudo inductor device as claimed in claim 16, wherein said contacts are harder than wires.

18. The pseudo inductor device as claimed in claim 16, wherein said traces are exposed upon a surface of the printed circuit board on which said core is seated.

19. The pseudo inductor device as claimed in claim 16, wherein said contacts and said traces have different cross-sectional dimensions from each other.

20. the pseudo inductor device as claimed in claim 16, further including another conductive path, similar to said conductive path, having the corresponding traces and contacts and winding along the core and intermingled with said conductive path in an alternate manner.
